(19) United States
(12) Patent Application Publication
(10) Pub. No.: US 2015/0067357 A1
(43) Pub. Date: Mar. 5, 2015

(54) PREDICTION FOR POWER GATING

(71) Applicant: Advanced Micro Devices, Inc., Sunnyvale, CA (US)

(72) Inventors: Manish Arora, Dublin, CA (US); Nuwan S. Jayasena, Sunnyvale, CA (US); Indrani Paul, Round Rock, TX (US); Michael J. Schulte, Austin, TX (US)

(73) Assignee: Advanced Micro Devices, Inc., Sunnyvale, CA (US)

(21) Appl. No.: 14/015,578

(22) Filed: Aug. 30, 2013

(51) Int. Cl. G06F 1/26

(52) U.S. Cl. CPC G06F 1/26
USPC 713/300

(57) ABSTRACT

The present application describes embodiments of methods for tournament prediction of power gating in processing devices. Some embodiments of the method include selecting one of a plurality of predictions of a duration of a time to a power state transition of a component in a processing device. The plurality of predictions are generated using a corresponding plurality of prediction algorithms. Some embodiments of the method also include deciding whether to transition the component from a first power state to a second power state based on the selected prediction.

### BACKGROUND

1. Field of the Disclosure

The present disclosure relates generally to processing devices and, in particular, to prediction for power gating in processing devices.

2. Description of the Related Art

Components in processing devices such as central processing units (CPUs), graphics processing units (GPUs), and accelerated processing units (APUs) can conserve power by idling when there are no instructions to be executed by the component of the processing device. If the component is idle for a relatively long time, power supplied to the processing device may then be gated so that no current is supplied to the component, thereby reducing stand-by and leakage power consumption. For example, a processor core in a CPU can be power gated if the processor core has been idle for more than a predetermined time interval. However, power gating consumes system resources. For example, power gating requires flushing caches in the processor core, which consumes both time and power. Power gating also exacts a performance cost to return the processor core to an active state. The idle time interval that elapses before power gating a component of a processing device may therefore be set to a relatively long time.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing device in accordance with some embodiments.

FIG. 2 is a block diagram of a tournament predictor that may be implemented in the tournament power gate logic shown in FIG. 1 in accordance with some embodiments.

FIG. 3 is a flow diagram of a method that may be implemented in the last value predictor shown in FIG. 2 in accordance with some embodiments.

FIG. 4 is a flow diagram of a method that may be implemented in the linear predictors shown in FIG. 2 in accordance with some embodiments.

FIG. 5 is a flow diagram of a method that may be implemented in the filtered linear predictor shown in FIG. 2 in accordance with some embodiments.

FIG. 6 is a diagram of a two-level adaptive global predictor that may be used in the two-level global predictor shown in FIG. 2 in accordance with some embodiments.

FIG. 7 is a diagram of a two-level adaptive local predictor that may be used in the two-level local predictor shown in FIG. 2 in accordance with some embodiments.

FIG. 8 is a flow diagram of a method of tournament power gating that may be implemented in the tournament power gate logic shown in FIG. 1 in accordance with some embodiments.

FIG. 9 is a flow diagram illustrating a method for designing and fabricating an integrated circuit device implementing at least a portion of a component of a processing system in accordance with some embodiments.

### DETAILED DESCRIPTION OF EMBODIMENT(S)

As discussed herein, power management techniques that change the power management state of a component of a processing device can consume a large amount of system resources relative to the resources conserved by the state change. For example, an idle processor core in a CPU may be power gated (i.e., the state of the processor core may be changed from an idle power management state to a power gated power management state) just before the processor core needs to reenter the active state, which may lead to unnecessary delays and waste of the power needed to flush the caches associated with the processor core and return the processor core to the active state. For another example, if the processor core is not going to be used for a relatively long time, the processor core may remain in the idle state for too long before entering the power-gated state, thereby wasting the resources that could have been conserved by entering the power-gated state earlier.

In order to better determine whether to transition between two power management states of a component, a processing device can employ prediction techniques to predict the duration of a duration of a current power management state of the component. The power management state of the component can then be changed from the current power management state to a different power management state if the prospective power management or performance gains exceed the prospective losses incurred by transitioning into the different power management state. For example, to decide whether to transition from an idle power management state to a power-gated power management state, a predicted idle time can be set equal to an average duration of the last few idle events during which the processing device was in an idle state. The average duration may also be calculated using weighted values of the durations and outlier events may be filtered prior to calculating the average. For another example, short duration predictors may use a pattern history table containing saturating counters to predict durations of subsequent idle events. The power supplied to the component can then be gated when the idle time is predicted to be larger than a breakeven value at which the power saved by power gating for the predicted time interval exceeds the cost of the power gating process. However, each technique may be accurate in some cases and inaccurate in other cases, and the conditions under which each technique is accurate may be different for the different techniques. Furthermore, predictions based on previous results can become highly inaccurate when the pattern of idle durations changes relative to the pattern established by the previous results.

Instead of relying on a single prediction technique, which may be inaccurate in some circumstances, the present application describes embodiments of a tournament predictor that can predict the duration of a power management state for a component of a processing device by selecting one of a plurality of predictions of the duration of the power management state generated using different prediction techniques. Some embodiments of the tournament predictor can select one of the predictions based on the previous accuracy of the different prediction techniques, e.g., using measures of the prior performance of the prediction techniques. The tournament predictor may also select the prediction based on confidence measures for the plurality of predictions. For example, an estimated error for a prediction can be used as a confidence measure of the prediction. For another example, values of the saturating counters used in the short duration predictors can be used as confidence measures of a prediction. Some embodiments can bypass or turn off one or more of the prediction algorithms when these algorithms provide minimal marginal improvement in the prediction accuracy. The tournament predictor is more accurate than individual prediction techniques at least in part because typical patterns of idle event durations are time variable and not always accurately captured by any single prediction technique. Improving the prediction accuracy allows processing devices to make more accurate power management decisions, thereby improving performance, reducing response time, and conserving power.

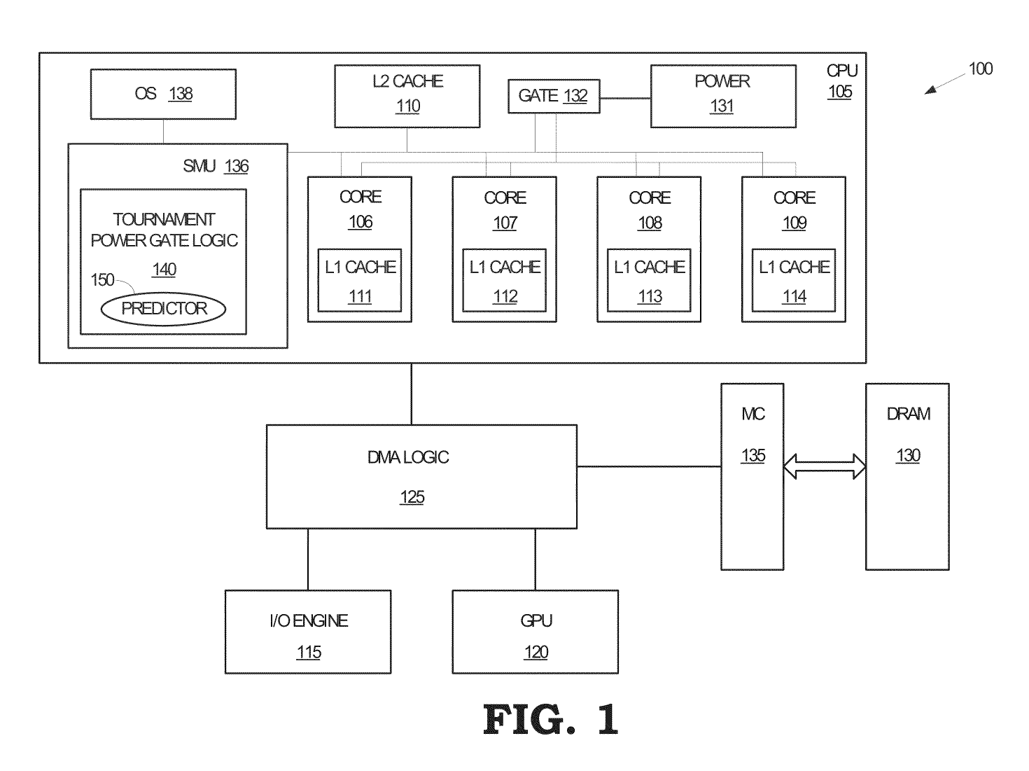

FIG. 1 is a block diagram of a processing device 100 in accordance with some embodiments. The processing system 100 includes a central processing unit (CPU) 105 for executing instructions. Some embodiments of the CPU 105 include multiple processor cores 106-109 that can independently execute instructions concurrently or in parallel. The CPU 105 shown in FIG. 1 includes four processor cores 106-109. However, persons of ordinary skill in the art having benefit of the present disclosure should appreciate that the number of processor cores in the CPU 105 is a matter of design choice. Some embodiments of the CPU 105 may include more or fewer than the four processor cores 106-109 shown in FIG. 1.

The CPU 105 implements caching of data and instructions and some embodiments of the CPU 105 may therefore implement a hierarchical cache system. For example, the CPU 105 may include an L2 cache 110 for caching instructions or data that may be accessed by one or more of the processor cores 106-109. Each of the processor cores 106-109 may also implement an L1 cache 111-114. Some embodiments of the L1 caches 111-114 may be subdivided into an instruction cache and a data cache.

The processing system 100 includes an input/output engine 115 for handling input or output operations associated with elements of the processing system such as keyboards, mice, printers, external disks, and the like. A graphics processing unit (GPU) 120 is also included in the processing system 100 for creating visual images intended for output to a display. Some embodiments of the GPU 120 may include multiple cores and/or cache elements that are not shown in FIG. 1 interest of clarity.

The processing system 100 shown in FIG. 1 also includes direct memory access (DMA) logic 125 for generating addresses and initiating memory read or write cycles. The CPU 105 may initiate transfers between memory elements in the processing system 100 such as the DRAM memory 130 and/or other entities connected to the DMA logic 125 including the CPU 105, the I/O engine 115 and the GPU 120. Some embodiments of the DMA logic 125 may also be used for memory-to-memory data transfer or transferring data between the cores 106-109. The CPU 105 can perform other operations concurrently with the data transfers being performed by the DMA logic 125 which may provide an interrupt to the CPU 105 to indicate that the transfer is complete.

A memory controller (MC) 135 may be used to coordinate the flow of data between the DMA logic 125 and the DRAM 130. The memory controller 135 includes logic used to control reading information from the DRAM 130 and writing information to the DRAM 130. The memory controller 135 may also include refresh logic that is used to periodically re-write information to the DRAM 130 so that information in the memory cells of the DRAM 130 is retained. Some embodiments of the DRAM 130 may be double data rate (DDR) DRAM, in which case the memory controller 135 may be capable of transferring data to and from the DRAM 130 on both the rising and falling edges of a memory clock.

Some embodiments of the CPU 105 may implement a system management unit (SMU) 136 that may be used to carry out policies set by an operating system (OS) 138 of the CPU 105. For example, the SMU 136 may be used to manage thermal and power conditions in the CPU 105 according to policies set by the OS 138 and using information that may be provided to the SME 136 by the OS 138, such as power consumption by entities within the CPU 105 or temperatures at different locations within the CPU 105. The SMU 136 may therefore be able to control power supplied to entities such as the cores 106-109, as well as adjusting operating points of the cores 106-109, e.g., by changing an operating frequency or an operating voltage supplied to the cores 106-109.

The SMU 136 can initiate transitions between power management states of the components of the processing system 100 such as the CPU 105, the GPU 120, or the cores 106-109 to conserve power. Exemplary power management states may include an active state, an idle state, a power-gated state, or other power management states in which the component may consume more or less power. Some embodiments of the SMU 136 determine whether to initiate transitions between the power management states by comparing the performance or power costs of the transition with the performance gains or power savings of the transition. Transitions may occur from higher to lower power management states or from lower to higher power management states. For example, some embodiments of the processing system 100 include a power supply 131 that is connected to gate logic 132. The gate logic 132 can control the power supplied to the cores 106-109 and can gate the power provided to one or more of the cores 106-109, e.g., by opening one or more circuits to interrupt the flow of current to one or more of the cores 106-109 in response to signals or instructions provided by the SMU 136. The gate logic 132 can also re-apply power to transition one or more of the cores 106-109 out of the power-gated state to an idle or active state, e.g., by closing the appropriate circuits. However, power gating components of the processing system 100 consumes system resources. For example, power gating the CPU 105 or the cores 106-109 may require flushing some or all of the L2 cache 110 and the L1 caches 111-114. Flushing one or more of the caches 110-114 consumes both time and power. Reentering the active state after being power gated also consumes significant resources of the processing system 100. Before deciding whether to power gate the component(s) or maintain or reenter the idle or active state, the resource savings resulting from power gating one or more components of the processing system 100 should therefore be weighed against the resource cost of power gating these components and subsequently reentering the active state.

Some embodiments of the SMU 136 may therefore implement tournament power gate logic 140 that is used to decide when to transition between power management states. For example, the SMU 136 may use the tournament power gate logic 140 to determine whether to power gate components of the processing device 100. However, persons of ordinary skill in the art should appreciate that some embodiments of the processing device 100 may implement the tournament power gate logic 140 in other locations or portions of the tournament power gate logic 140 may be distributed to multiple locations within the processing device 100. The tournament power gate logic 140 includes a tournament predictor 145 that can predict the durations of power management states (such as idle events) for components of the processing device 100 such as the CPU 105, the GPU 120, as well as components at a finer level of granularity such as the processor cores 106-109 and/or cores within the GPU 120. For example, the duration of a power management state may be measured as the predicted time until a transition to a different power management state. The predictor 150 implements multiple algorithms for predicting the duration of the power management state for one or more components in the processing device 100. The predictor 150 may then select one prediction from among the predictions of the different algorithms.

The tournament power gate logic 140 may use the selected prediction to decide whether to transition between different power management states, e.g., whether to power gate one or more idle components of the processing device 100. Some embodiments of the tournament predictor 150 can select the prediction based on the previous accuracy of the algorithms and/or confidence measures for each of the predictions. Some embodiments of the tournament predictor 150 can bypass or turn off one or more of the prediction algorithms when the tournament predictor 150 can determine that the bypassed algorithm provides minimal marginal improvement in the prediction accuracy. For example, a prediction algorithm may be turned off when the tournament predictor 150 determines that the algorithm has provided a marginal improvement in the prediction accuracy that is less than a threshold during one or more previous prediction iterations.

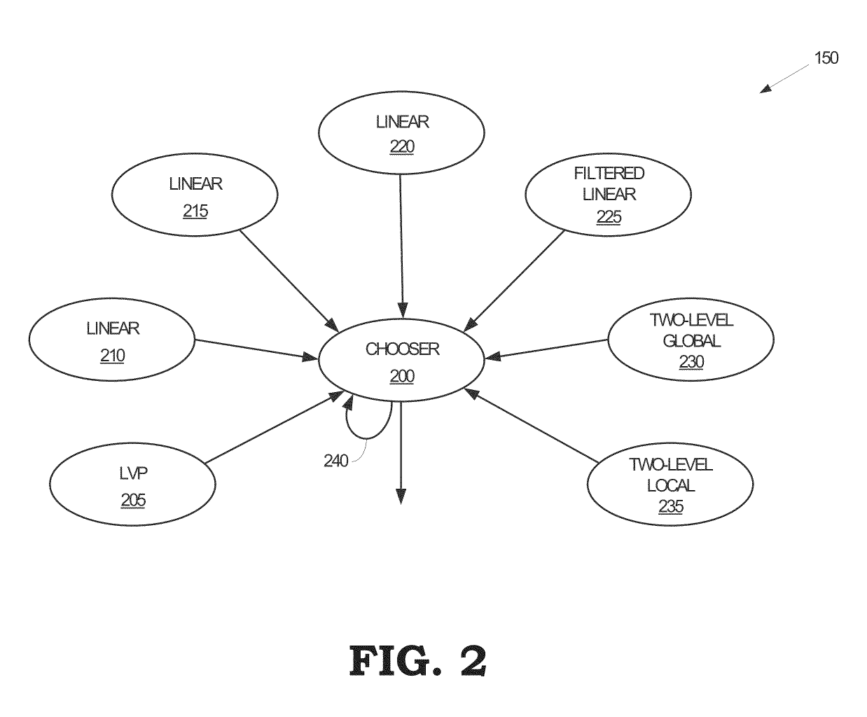

FIG. 2 is a block diagram of a tournament predictor 150 that may be implemented in the tournament power gate logic 140 shown in FIG. 1 in accordance with some embodiments. The tournament predictor 150 includes a chooser 200 that is used to select one of a plurality of predictions of an idle time duration provided by a plurality of different prediction algorithms. However, some embodiments of the chooser 200 may be used to select between predictions of other power management states, as discussed herein. Exemplary prediction algorithms include a last value predictor (LVP) 205, a first linear prediction algorithm 210 that uses a first training length and a first set of linear coefficients, a second linear prediction algorithm 215 that uses a second training length and a second set of linear coefficients, a third linear prediction algorithm 220 that uses a third training length and a third set of linear coefficients, a filtered linear prediction algorithm 225 that uses a fourth training length and a fourth set of linear coefficients, a two-level global predictor 230, and a two-level local predictor 235. However, persons of ordinary skill in the art having benefit of the present disclosure should appreciate that the selection of algorithms shown in FIG. 2 is exemplary and some embodiments may include more or fewer algorithms of the same or different types.

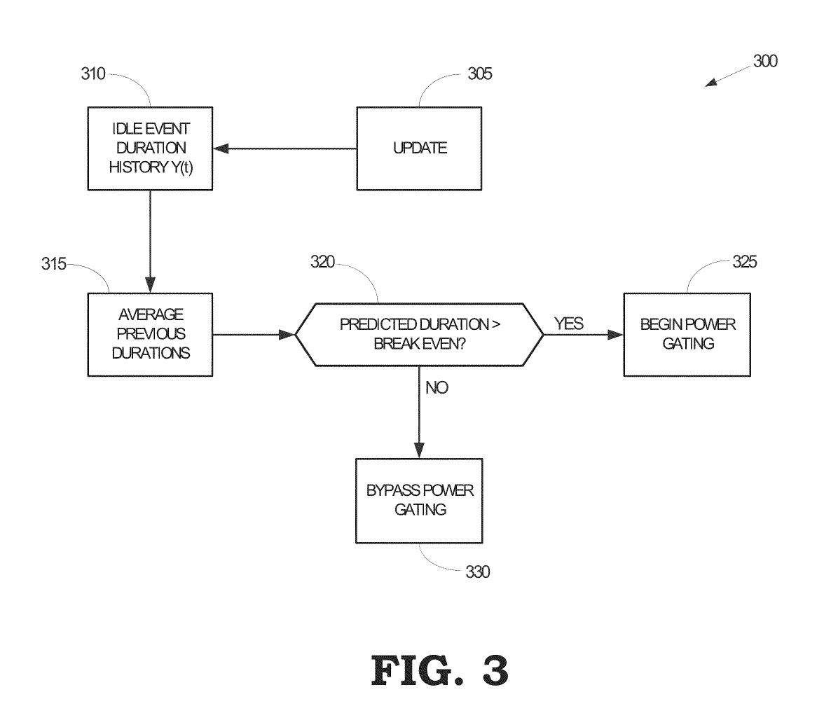

FIG. 3 is a flow diagram of a method 300 that may be implemented in the last value predictor 205 shown in FIG. 2 in accordance with some embodiments. At block 305, a value of a duration of an idle time event associated with a component in a processing device is updated, e.g., in response to the component re-activating from the idle state so that the total duration of the idle event can be measured by the last value predictor. The total duration of the idle event is the time that elapses between entering the idle state and re-activating from the idle state. At block 310, the updated value of the duration is used to update an idle event duration history that includes a predetermined number of previous idle event durations. For example, the idle event duration history, Y(t), may include information indicating the durations of the last ten idle events so that the training length of the last value predictor is ten. The training length is equal to the number of previous idle events used to predict the duration of the next idle event.

At block 315, an average of the durations of the idle events in the idle event history is calculated, e.g., using the following formula for computing the average of the last ten idle events:

$$\overline{Y ( t )} = {\sum }_{i = 1}^{10} 0.1 * Y ( t - i )$$

Persons of ordinary skill in the art having benefit of the present disclosure should appreciate that some embodiments of the method 300 may use more or fewer than ten events from the idle event history to calculate the average of the durations. Some embodiments of the method 300 may also generate a measure of the prediction error that indicates the proportion of the signal that is well modeled by the last value predictor model. For example, the method 300 may produce a measure of prediction error based on the training data set. Measures of the prediction error may include differences between the durations of the idle events in the idle event history and the average value of the durations of the idle events in the idle event history. The measure of the prediction error may be used as a confidence measure for the predicted idle time duration, as discussed herein.

At decision block 320, the predicted duration, which is equal to the average of the previous durations, may be compared to a breakeven duration. In some embodiments, the breakeven duration is equal to the duration at which the resource cost of power gating a component is equal to the resource savings that would result from power gating the component for the breakeven duration. The breakeven duration may therefore be determined on a component-by-component basis and may be determined using empirical studies, performance testing, modeling, or other techniques. A net resource savings may result if the predicted duration is greater than the breakeven duration. The processing device may therefore begin a power gating the component at 325 if the predicted duration is greater than the breakeven duration. If not, the processing device may bypass or turn off power gating the component at 330.

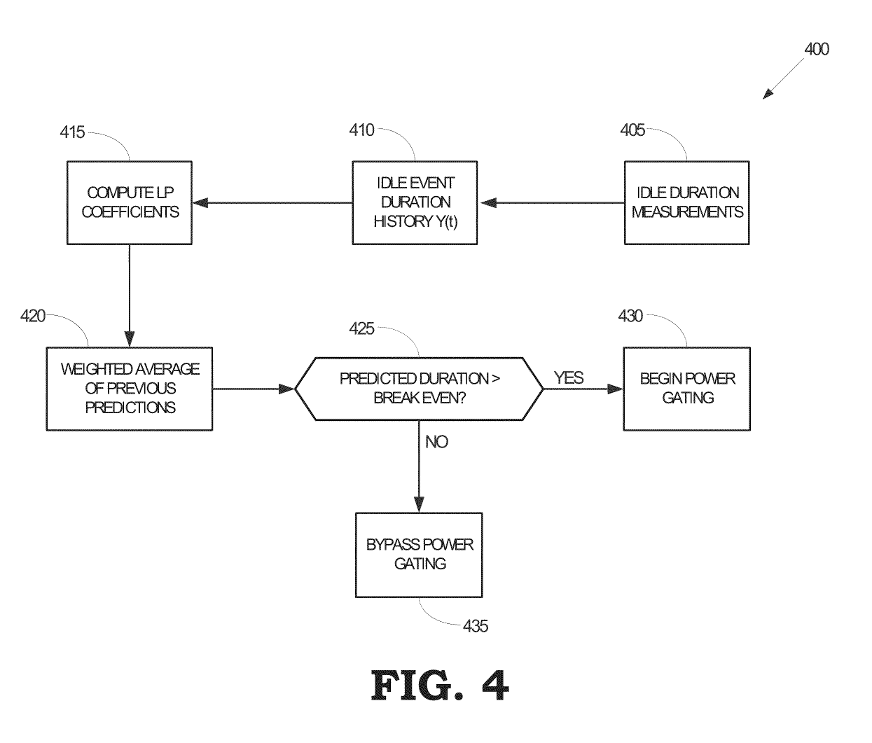

FIG. 4 is a flow diagram of a method 400 that may be implemented in the linear predictors 210, 215, 220 shown in FIG. 2 in accordance with some embodiments. At block 405, one or measurements of an idle time duration are received by the linear predictor algorithm. The measurements may be received via an operating system, a system management unit, or other hardware, firmware, or software implemented in the processing device. At block 410, the measured value(s) of the duration may be used to update an idle event duration history that includes a predetermined number of previous idle event durations that corresponds to the training length of the linear predictor. For example, the idle event duration history, Y(t), may include information indicating the durations of the last N idle events so that the training length of the linear predictor is N. At block 415, a predetermined number of linear predictor coefficients a(i) are computed. The sequence of idle event durations may include different durations and the linear predictor coefficients a(i) may be used to define a model of the progression of idle event durations that can be used to predict the next idle event duration.

At block 420, a weighted average of the durations of the idle events in the idle event history is calculated using the coefficients calculated at block 415, e.g., using the following formula for computing the average of the last N idle events:

$$\overline{Y ( t )} = {\sum }_{i = 1}^{N} a ( i ) * Y ( t - i )$$

Persons of ordinary skill in the art having benefit of the present disclosure should appreciate that different embodiments of the linear predictor algorithm may use different training lengths and/or numbers of linear predictor coefficients. For example, the linear predictors 210, 215, 220 shown in FIG. 2 may each use different training lengths and numbers of linear predictor coefficients. Some embodiments of the method 400 may also generate a measure of the prediction error that indicates the proportion of the signal that is well modeled by the linear predictor model, e.g., how well the linear predictor model would have predicted the durations in the idle event history. For example, the method 400 may produce a measure of prediction error based on the training data set. The measure of the prediction error may be used as a confidence measure for the predicted idle time duration, as discussed herein.

At decision block 425, the predicted duration, which is equal to the weighted average of the previous durations, may be compared to a breakeven duration. The processing device may begin a power gating the component at 430 if the predicted duration is greater than the breakeven duration. If not, the processing device may bypass power gating a component at 435.

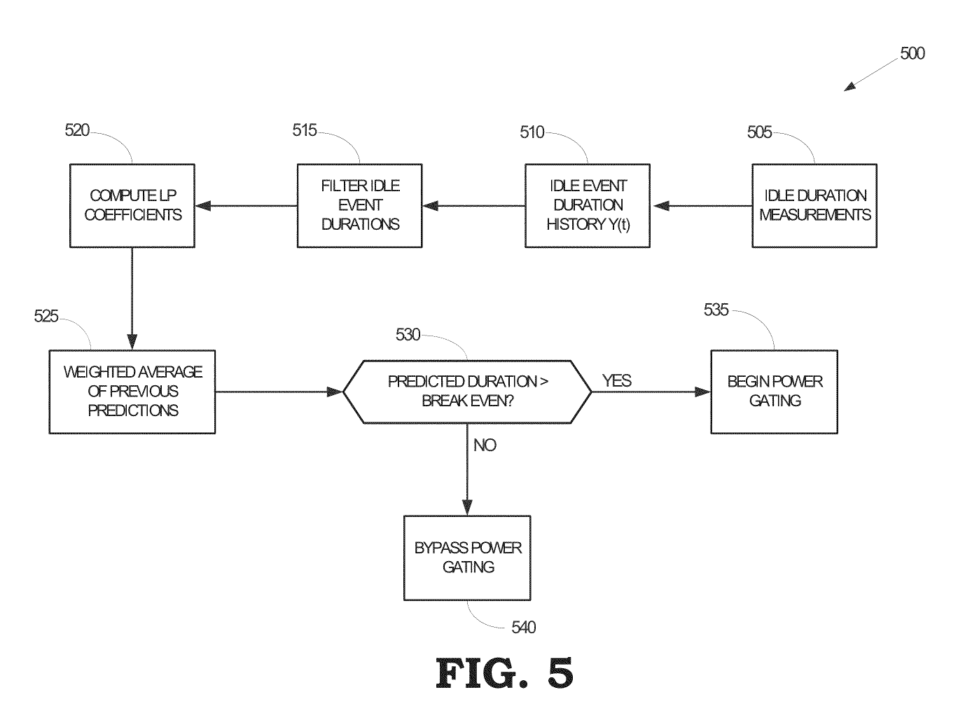

FIG. 5 is a flow diagram of a method 500 that may be implemented in the filtered linear predictor 225 shown in FIG. 2 in accordance with some embodiments. At block 505, one or measurements of an idle time duration are received by the linear predictor algorithm. The measurements may be received via an operating system, a system management unit, or other hardware, firmware, or software implemented in the processing device. At block 510, the measured value(s) of the duration may be used to update an idle event duration history that includes a predetermined number of previous idle event durations that corresponds to the training length of the linear predictor. For example, the idle event duration history, Y(t), may include information indicating the durations of the last N idle events so that the training length of the last value predictor is N. At block 515, the idle event duration history is filtered. For example, the idle event duration history may be filtered to remove outlier idle events such as events that are significantly longer or significantly shorter than the mean value of the idle event durations in the history.

At block 520, a predetermined number of linear predictor coefficients a(i) are computed using the filtered idle event history. At block 525, a weighted average of the durations of the idle events in the filtered idle event history is calculated using the coefficients calculated at block 520, e.g., using the following formula for computing the weighted average of the last N idle events in the filtered idle event history Y′:

$$\overline{Y ( t )} = {\sum }_{i = 1}^{N} a ( i ) * {Y}^{′} ( t - i )$$

Persons of ordinary skill in the art having benefit of the present disclosure should appreciate that different embodiments of the filtered linear predictor algorithm may use different filters, training lengths, and/or numbers of linear predictor coefficients. Some embodiments of the method 500 may also generate a measure of the prediction error that indicates the proportion of the signal that is well modeled by the filtered linear predictor model. For example, the method 500 may produce a measure of prediction error based on the training data set. The measure of the prediction error may be used as a confidence measure for the predicted idle time duration, as discussed herein.

At decision block 530, the predicted duration, which is equal to the weighted average of the previous durations in the filtered history, may be compared to a breakeven duration. The processing device may begin a power gating the component at 535 if the predicted duration is greater than the breakeven duration. If not, the processing device may bypass power gating the component at 540.

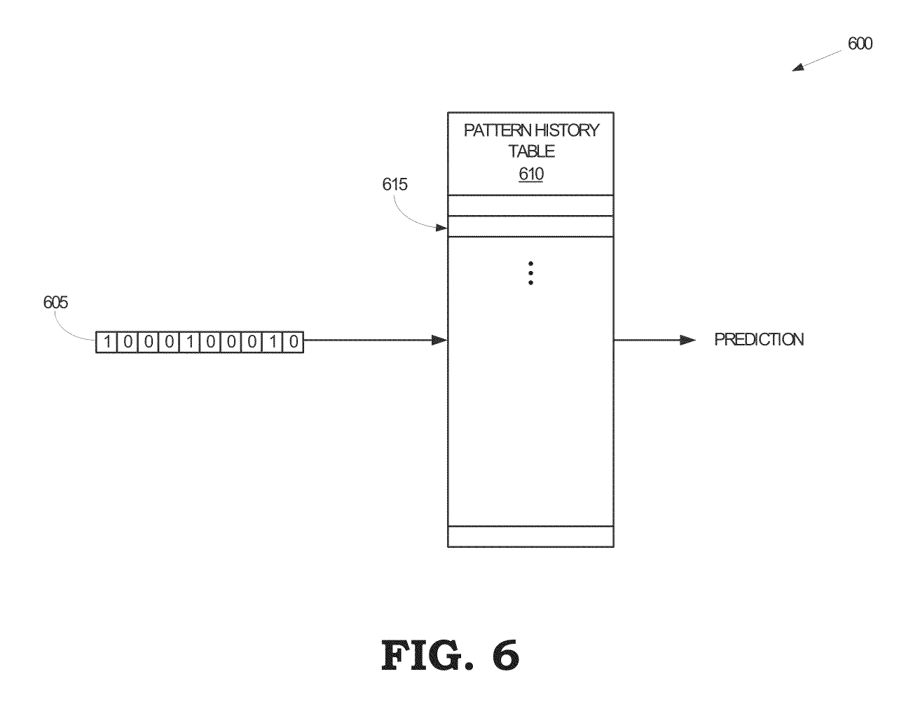

FIG. 6 is a diagram of a two-level adaptive global predictor 600 that may be used in the two-level global predictor 230 shown in FIG. 2 in accordance with some embodiments. The two levels used by the global predictor 600 correspond to long and short durations of an idle time event. For example, a value of “1” may be used to indicate an idle time event that has a duration that is longer than a threshold and a value of “0” may be used to indicate an idle time event that has a duration that is shorter than the threshold. The threshold may be set based on the breakeven duration discussed herein. The global predictor 600 receives information indicating the duration of idle events and uses this information to construct a pattern history 605 for long or short duration events. The pattern history 605 includes information for a predetermined number N of idle time events, such as the ten idle time events shown in FIG. 6.

A pattern history table 610 includes 2^{N} entries 615 that correspond to each possible combination of long and short durations in the N idle time events. Each entry 615 in the pattern history table 610 is also associated with a saturating counter that can be incremented or decremented based on the values in the pattern history 605. An entry 615 may be incremented when the pattern associated with the entry 615 is received in the pattern history 605 and is followed by a long-duration event. The saturating counter can be incremented until the saturating counter saturates at a maximum value (e.g., all “1s”) that indicates that the current pattern history 605 is very likely to be followed by a long duration idle event. An entry 615 may be decremented when the pattern associated with the entry 615 is received in the pattern history 605 and is followed by a short-duration event. The saturating counter can be decremented until the saturating counter saturates at a minimum value (e.g., all “0s”) that indicates that the current pattern history 605 is very likely to be followed by a short duration idle event.

The two-level global predictor 600 may predict that an idle event is likely to be a long-duration event when the saturating counter in an entry 615 that matches the pattern history 605 has a relatively high value of the saturating counter such as a value that is close to the maximum value. The two-level global predictor 600 may predict that an idle event is likely to be a short-duration event when the saturating counter in an entry 615 that matches the pattern history 605 has a relatively low value of the saturating counter such as a value that is close to the minimum value.

Some embodiments of the two-level global predictor 600 may also provide a confidence measure that indicates a degree of confidence in the current prediction. For example, a confidence measure can be derived by counting the number of entries 615 that are close to being saturated (e.g., are close to the maximum value of all “1s” or the minimum value of all “0s”) and comparing this to the number of entries that do not represent a strong bias to long or short duration idle time events (e.g., values that are approximately centered between the maximum value of all “1s” and the minimum value of all “0s”). If the ratio of saturated to unsaturated entries 615 is relatively large, the confidence measure indicates a relatively high degree of confidence in the current prediction and if this ratio is relatively small, the confidence measure indicates a relatively low degree of confidence in the current prediction.

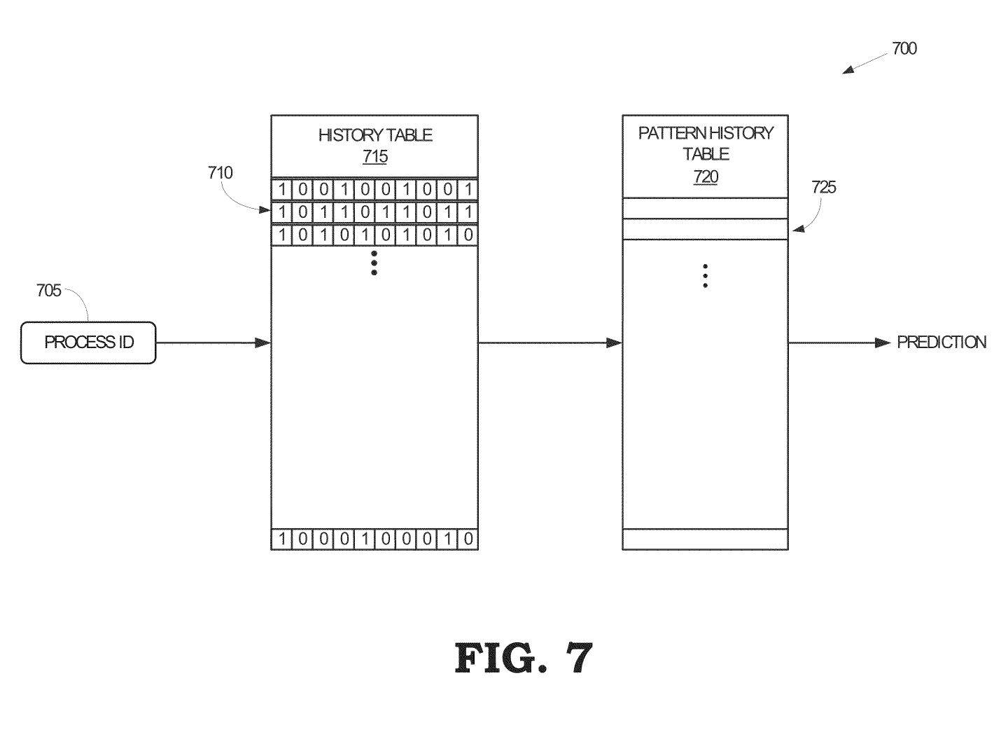

FIG. 7 is a diagram of a two-level adaptive local predictor 700 that may be used in the two-level local predictor 235 shown in FIG. 2 in accordance with some embodiments. As discussed herein, the two levels used by the local predictor 700 correspond to long and short durations of a corresponding idle time event. The two-level local predictor 700 receives a process identifier 705 that can be used to identify a pattern history entry 710 in a history table 715. Each pattern history entry 710 is associated with a process and includes a history that indicates whether previous idle event durations associated with the corresponding process were long or short.

A pattern history table 720 includes 2^{N} entries 725 that correspond to each possible combination of long and short durations in the N idle time events in each of the entries 710. Some embodiments of the local predictor 700 may include a separate pattern history table 720 for each process. Each entry 725 in the pattern history table 720 is also associated with a saturating counter. As discussed herein, the entries 725 may be incremented or decremented when the pattern associated with the entry 725 matches the pattern in the entry 710 associated with the process identifier 705 and is followed by a long-duration event or a short-duration event, respectively.

The two-level local predictor 700 may then predict that an idle event is likely to be a long-duration event when the saturating counter in an entry 725 that matches the pattern in the entry 710 associated with the process identifier 705 has a relatively high value of the saturating counter such as a value that is close to the maximum value. The two-level global predictor 700 may predict that an idle event is likely to be a short-duration event when the saturating counter in an entry 725 that matches the pattern in the entry 710 associated with the process identifier 705 has a relatively low value of the saturating counter such as a value that is close to the minimum value.

Some embodiments of the two-level local predictor 700 may also provide a confidence measure that indicates a degree of confidence in the current prediction. For example, a confidence measure can be derived by counting the number of entries 725 that are close to being saturated (e.g., are close to the maximum value of all “1s” or the minimum value of all “0s”) and comparing this to the number of entries 725 that do not represent a strong bias to long or short duration idle time events (e.g., values that are approximately centered between the maximum value of all “1s” and the minimum value of all “0s”). If the ratio of saturated to unsaturated entries 725 is relatively large, the confidence measure indicates a relatively high degree of confidence in the current prediction and if this ratio is relatively small, the confidence measure indicates a relatively low degree of confidence in the current prediction.

Referring back to FIG. 2, the chooser 200 may access the idle time duration predictions provided by the prediction algorithms 205, 210, 215, 220, 225, 230, 235 and then select one of the predictions. Some embodiments of the chooser 200 may select one of the predictions of the idle time duration based on a measure of the previous accuracy of each of the prediction algorithms 205, 210, 215, 220, 225, 230, 235. For example, the tournament predictor 150 may maintain a record indicating the previous success rate or accuracy of a predetermined number of predictions (e.g., the last 500 predictions) made by each of the prediction algorithms 205, 210, 215, 220, 225, 230, 235. The information indicating the previous success rate or accuracy is indicated as a feedback arrow 240 in FIG. 2. The chooser 200 may then select the prediction made by the prediction algorithm with the highest success rate or accuracy. Some embodiments of the chooser 200 may also allow the different prediction algorithms 205, 210, 215, 220, 225, 230, 235 to vote for the most accurate prediction. For example, the chooser 200 may select the prediction that has been predicted by the largest number of the prediction algorithms. Some embodiments of the chooser 200 may use weighted schemes that emphasize accuracy in recent predictions over the predictions made further in the past.

Some embodiments of the chooser 200 may also select the predicted idle time duration based on confidence measures provided by each of the prediction algorithms 205, 210, 215, 220, 225, 230, 235. As discussed herein, the confidence measure provides an indication of the confidence that the prediction algorithm has in its current prediction. The confidence measure therefore provides complementary information to the information provided by the measure of the previous success rate or accuracy of the prediction algorithms 205, 210, 215, 220, 225, 230, 235. For example, changes in a program or instructions being executed by the processing device may result in the accuracy of some of the prediction algorithms 205, 210, 215, 220, 225, 230, 235 declining and the accuracy of other prediction algorithms 205, 210, 215, 220, 225, 230, 235 improving. In that case, indications of the previous success rate or accuracy may not be a reliable indicator of the current or future success rate or accuracy of the prediction algorithms 205, 210, 215, 220, 225, 230, 235. In contrast, the confidence measure may provide a more accurate indication of the current or future success rate or accuracy of the prediction algorithms 205, 210, 215, 220, 225, 230, 235 in this circumstance.

Once the chooser 200 has selected one of the predictions made by the prediction algorithms 205, 210, 215, 220, 225, 230, 235, logic such as the tournament power gate logic 140 shown in FIG. 1 can use the predicted idle time duration to decide whether to power gate the component based on the selected prediction, as discussed herein. Some embodiments of the chooser 200 may also turn one or more of the prediction algorithms 205, 210, 215, 220, 225, 230, 235 on or off. For example, the chooser 200 may decide to turn off one or more of the prediction algorithms 205, 210, 215, 220, 225, 230, 235 that provide a small marginal improvement in the overall accuracy of the tournament prediction algorithm. Turning off one or more of the prediction algorithms 205, 210, 215, 220, 225, 230, 235 may save resources of the processing device including power and processing time without significantly reducing the accuracy of the predictions.

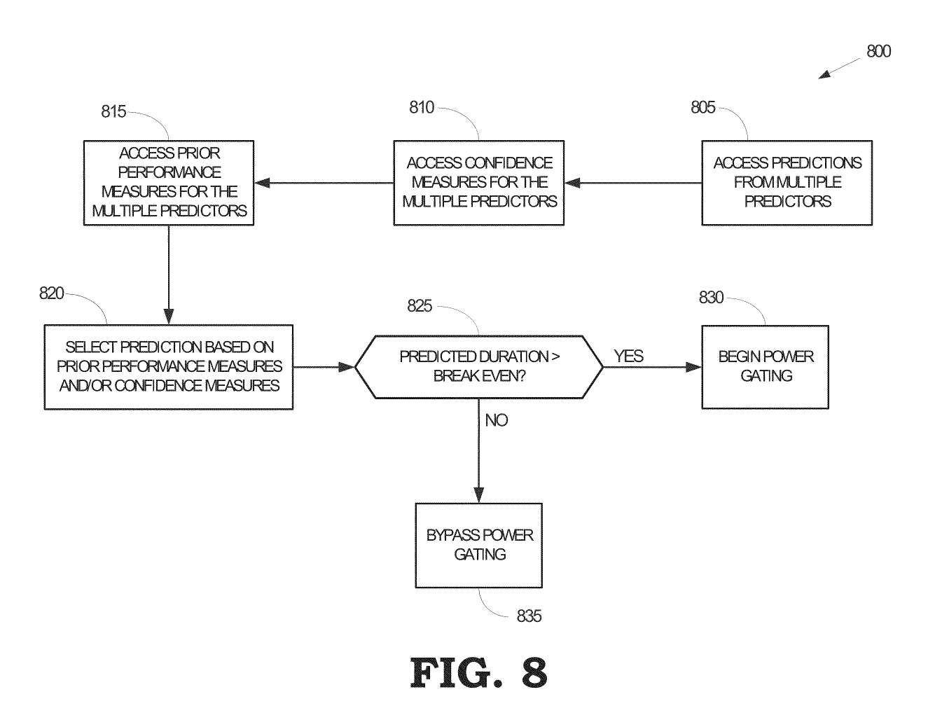

FIG. 8 is a flow diagram of a method 800 of tournament power gating that may be implemented in the tournament power gate logic 140 shown in FIG. 1 in accordance with some embodiments. At block 805, the tournament power gate logic accesses predictions of an idle time duration that are generated by multiple prediction algorithms. At block 810, the tournament power gate logic accesses confidence measures for the multiple predictions generated by the prediction algorithms. At block 815, the tournament power gate logic accesses prior performance measures that indicate the prior success rate or accuracy of the prediction algorithms. At block 820, a chooser such as the chooser 200 shown in FIG. 2 may then select one of the predictions based on the prior performance measures and/or the confidence measures provided by the different prediction algorithms, as discussed herein.

At decision block 825, the selected prediction of the idle event duration may be compared to a breakeven duration that is equal to the duration at which the resource cost of power gating a component is equal to the resource savings that would result from power gating the component for the breakeven duration. A net resource savings may result if the predicted duration is greater than the breakeven duration. The processing device may therefore begin a power gating the component at 830 if the predicted duration is greater than the breakeven duration. If not, the processing device may bypass power gating the component at 835.

In some embodiments, the apparatus and techniques described above are implemented in a system comprising one or more integrated circuit (IC) devices (also referred to as integrated circuit packages or microchips), such as the tournament predictor described above with reference to FIGS. 1-8. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

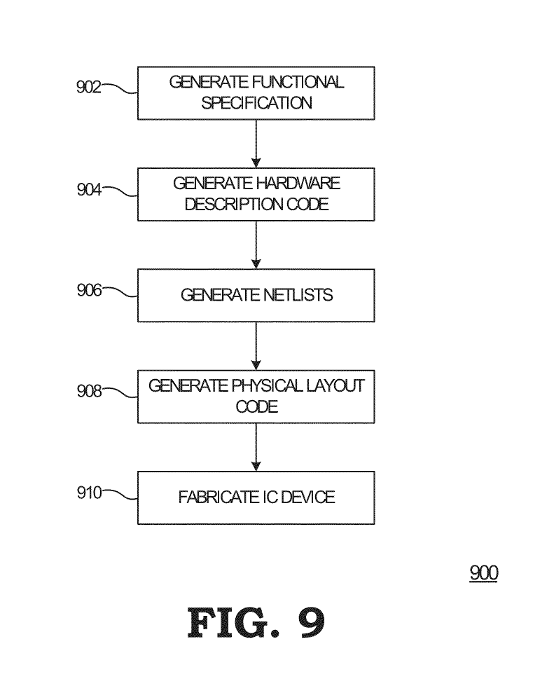

FIG. 9 is a flow diagram illustrating an example method 900 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 902 a functional specification for the IC device is generated. The functional specification (often referred to as a micro architecture specification (MAS)) may be represented by any of a variety of programming languages or modeling languages, including C, C++, SystemC, Simulink, or MATLAB.

At block 904, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 906 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 908, one or more EDA tools use the netlists produced at block 906 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 910, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
selecting one of a plurality of predictions of a duration of a time to a power state transition of a component in a processing device, wherein the plurality of predictions are generated using a corresponding plurality of prediction algorithms; and
deciding whether to transition the component from a first power state to a second power state based on the selected prediction.

2. The method of claim 1, wherein selecting said one of the plurality of predictions comprises selecting one of a plurality of predictions of a duration of an idle time event, and wherein deciding whether to transition the component comprises deciding whether to power gate the component based on the selected prediction of the duration of the idle time event.

3. The method of claim 1, wherein selecting said one of the plurality of predictions comprises selecting said one of the plurality of predictions based on a plurality of measures of the previous accuracy of the plurality of prediction algorithms.

4. The method of claim 3, wherein selecting said one of the plurality of predictions comprises at least one of selecting a prediction made by one of the plurality of prediction algorithms having the highest average accuracy within a history of previous predictions.

5. The method of claim 3, wherein selecting said one of the plurality of predictions comprises selecting said one of the plurality of predictions based on votes cast by the plurality of prediction algorithms so that said one of the plurality of predictions has a value that corresponds to a most frequent prediction of the plurality of prediction algorithms.

6. The method of claim 1, wherein selecting said one of the plurality of predictions comprises selecting said one of the plurality of predictions based on a plurality of confidence measures associated with the plurality of predictions.

7. The method of claim 6, wherein the plurality of confidence measures comprise a measure of a prediction error on a training data set used by a prediction algorithm.

8. The method of claim 6, wherein the plurality of confidence measures comprise a relative number of saturated and unsaturated saturating counters associated with a prediction algorithm.

9. The method of claim 1, wherein the plurality of prediction algorithms comprise at least one of a last value prediction algorithm, a weighted linear prediction algorithm, a filtered linear prediction algorithm, a local two-level predictor, or a global two-level predictor.

10. The method of claim 1, comprising omitting at least one of the prediction algorithms from the plurality of prediction algorithms in response to said at least one of the prediction algorithms providing a marginal increase in prediction accuracy that is lower than a threshold.

11. The method of claim 1, wherein deciding whether to transition the component comprises transitioning the component from the first power management state to the second power management state in response to the predicted duration being longer than a breakeven duration at which predicted savings from transitioning the component for the predicted duration exceed the cost of transitioning the component.

12. A processing device, comprising:
tournament prediction logic to select one of a plurality of predictions of a duration of a time to a power management state transition of a component in the processing device, wherein the plurality of predictions are generated using a corresponding plurality of prediction algorithms, and to decide whether to transition the component from a first power management state to a second power management state based on the selected prediction.

13. The processing device of claim 12, wherein the tournament prediction logic is to select one of a plurality of predictions of a duration of an idle time event, and wherein the tournament prediction logic is to decide whether to power gate the component based on the selected prediction of the duration of the idle time event.

14. The processing device of claim 12, wherein the tournament prediction logic is to select said one of the plurality of predictions based on a plurality of measures of the previous accuracy of the plurality of prediction algorithms.

15. The processing device of claim 12, wherein the tournament prediction logic is to select a prediction made by one of the plurality of prediction algorithms having the highest average accuracy within a history of previous predictions.

16. The processing device of claim 12, wherein the tournament prediction logic is to select said one of the plurality of predictions based on votes cast by the plurality of prediction algorithms so that said one of the plurality of predictions has a value that corresponds to a most frequent prediction of the plurality of prediction algorithms.

17. The processing device of claim 12, wherein the tournament prediction logic is to select said one of the plurality of predictions based on a plurality of confidence measures associated with the plurality of predictions.

18. The processing device of claim 17, wherein the plurality of confidence measures comprise a measure of a prediction error on a training data set used by a prediction algorithm.

19. The processing device of claim 17, wherein the plurality of confidence measures comprise a relative number of saturated and unsaturated saturating counters associated with a prediction algorithm.

20. The processing device of claim 12, wherein the plurality of prediction algorithms comprise at least one of a last value prediction algorithm, a weighted linear prediction algorithm, a filtered linear prediction algorithm, a local two-level predictor, or a global two-level predictor.

21. The processing device of claim 12, wherein the tournament prediction logic is to remove at least one of the prediction algorithms from the plurality of prediction algorithms in response to said at least one of the prediction algorithms providing a small marginal increase in prediction accuracy.

22. The processing device of claim 12, wherein the tournament prediction logic is to provide a signal for transitioning the component in response to the predicted duration being longer than a breakeven duration at which predicted savings from transitioning the component from the first power management state to the second power management state for the predicted duration exceed the cost of transitioning the component.

23. A method comprising:
selecting one of a plurality of predictions of a duration of an idle time event of a component in a processing device, wherein the plurality of predictions are generated using a corresponding plurality of prediction algorithms; and
deciding whether to power gate the component based on the selected prediction.

24. A processing device, comprising:
tournament prediction logic to select one of a plurality of predictions of a duration of an idle time event of a component in the processing device, wherein the plurality of predictions are generated using a corresponding plurality of prediction algorithms, and to decide whether to power gate the component based on the selected prediction.

25. A method comprising:
selecting one of a plurality of predictions of a duration of a time until activation a power-gated component in a processing device, wherein the plurality of predictions are generated using a corresponding plurality of prediction algorithms; and
deciding whether to transition the power-gated component to a different power management state based on the selected prediction.

26. A processing device, comprising:
tournament prediction logic to select one of a plurality of predictions of a duration of a time until activation of a power-gated component in the processing device, wherein the plurality of predictions are generated using a corresponding plurality of prediction algorithms, and to decide whether to transition the power-gated component to another power management state based on the selected prediction.
